(19) United States
(12) Patent Application Publication
(10) Pub. No.: US 2022/0227407 A1
(43) Pub. Date: Jul. 21, 2022

(54) VEHICLE COMBINATION

(71) Applicants: Jerzy Franciszek KUCHARKO, Wein (AT); FIRST WEST GMBH, Wien (AT)

(72) Inventor: Jerzy Franciszek KUCHARKO, Wien (AT)

(73) Assignees: FIRST WEST GMBH, Wien (AT); Jerzy Franciszek KUCHARKO, Wein (AT)

(21) Appl. No.: 17/604,091

(22) PCT Filed: Apr. 15, 2020
(86) PCT No.: PCT/AT2020/000007

§ 371 Date: Oct. 15, 2021

(30) Foreign Application Priority Data
Apr. 15, 2019 (AT) A 134/2019
Feb. 18, 2020 (AT) A 42/2020

(51) Int. Cl. B62B 5/00; B62B 9/26; B62B 9/28; B62H 3/12

(52) U.S. Cl. CPC B62B 5/0016; B62B 9/26; B62B 2202/90; B62H 3/12; B62B 9/28

(57) ABSTRACT

A vehicle combination which includes a perambulator and a trailer connected thereto, the trailer having a platform and casters which support the platform on the ground. The vehicle combination has two retaining devices for connection to a children's bicycle. The first retaining device is located on the trailer and is provided in order to fix a wheel of the children's bicycle. The second retaining device is located on the perambulator and is provided in order to fix the region of the children's bicycle which is located near the handle region of the perambulator if the children's bicycle is pivoted upwards about the axis of the wheel fixed on the retaining device on the trailer.

The invention relates to a vehicle combination which comprises a baby carriage and a trailer connected thereto.

Within the meaning of the present document, a trailer is a device that can be anchored to a road vehicle such that it is behind said road vehicle in the direction of travel thereof and can be pulled along thereby, wherein the device is stabilized against the underlying surface on casters, which are part of the device, and rolls on the casters.

Documents CA2033896 A1, DE9301375 U1, DE10130817 A1, US2007114738 A1 and WO200069699 A1 disclose examples of trailers for a baby carriage. The trailers have a board-like standing surface, which is equipped on its bottom side with one or more rotatably mounted casters and has an attachment device for attaching an edge of the standing surface to the rear axle of a baby carriage. In the assembled state, the standing surface protrudes rearward from the rear axle of the baby carriage, parallel to the direction of travel, and is stabilized by the caster(s) against the underlying surface on which it is able to travel. A child can stand on the standing surface and hold on to the handlebar of the baby carriage; the child can thus be moved together with a second infant lying or sitting in the baby carriage. DE 202009008584 U1 discloses a trailer of this kind, which is additionally equipped with a child seat. None of the documents propose attaching a further children's vehicle to the trailer.

WO 2008007250 A2 discloses a transport device which can be used to tow a children's bicycle while walking. The transport device consists of a platform, which is stabilized on casters against the underlying surface and has a slot intended for insertion of the front wheel of a children's bicycle from above—as is the case with some bicycle stands—with the result that the bicycle is held in place thereby. In the front region, the platform is equipped with an attachment option for a handle part, which can be a rod or a rope. There is nothing to suggest that the device is envisaged for use as a trailer on a vehicle.

DE 20112149 U1 discloses a trailer on a bicycle, to which in turn a children's bicycle can be secured so that it is pulled along by the trailer. The trailer has a platform which is stabilized in the downward direction against the underlying surface via casters and bounds a part that delimits an upwardly open groove, into which the lower part of the front wheel of the children's bicycle is intended to project from above. The free ends of the axles of the front wheel of the children's bicycle come to rest, from above, in a respective recess of a support part which projects upward from the platform. There is nothing to suggest that the device is envisaged for use as a trailer on a baby carriage.

The object on which the invention is based is to provide a supervising person with a a safe and comfortable transport option for two children when one child is in a baby carriage to be pushed by the supervising person and a children's bicycle for the second child is to be carried along when not being used by the second child.

For the achievement of the object, it is proposed that a vehicle combination is formed from the baby carriage and a trailer connected thereto, wherein the vehicle combination has two retaining devices for connecting a children's bicycle to the vehicle combination, wherein a first retaining device is located on the trailer and is designed to secure a wheel—preferably the rear wheel—of a children's bicycle, and wherein the second retaining device is located on the baby carriage, preferably on its handle region, and is designed to secure that region of the children's bicycle which is then located close to the handle region of the baby carriage when the children's bicycle is pivoted upward about the axis of the wheel located on the retaining device on the trailer.

This type of attachment makes it possible to move the children's bicycle together with the vehicle combination without major hindrance. That child otherwise able to use the children's bicycle independently can either walk along on foot or sit on the trailer.

The invention will be explained in more detail with reference to drawings relating to exemplary advantageous embodiments:

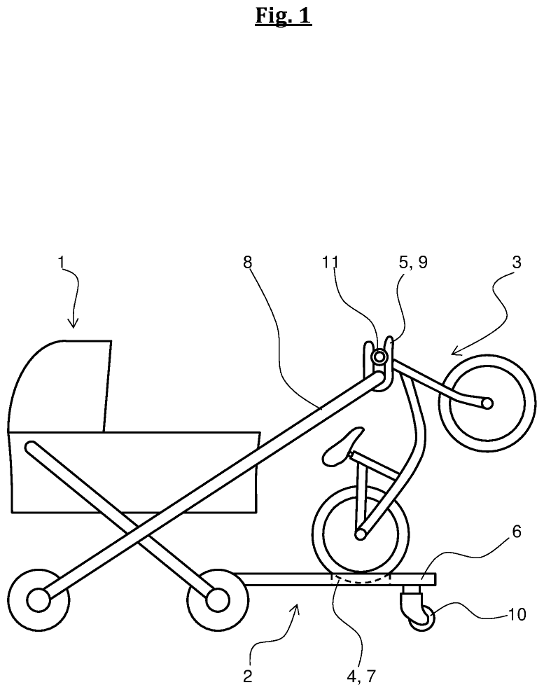

FIG. 1: shows a highly stylized side view of a first vehicle combination according to the invention with a children's bicycle attached thereto.

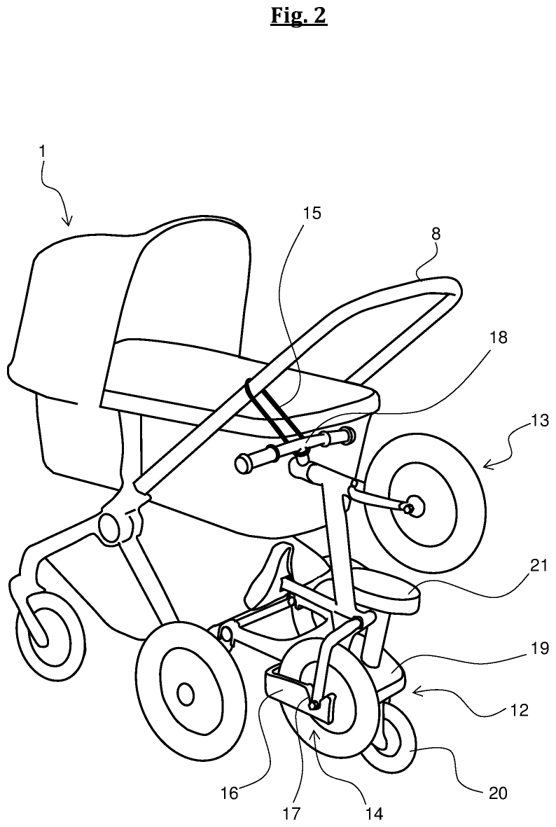

FIG. 2: shows an oblique view from the rear and above of a second vehicle combination according to the invention with a children's bicycle attached thereto.

The vehicle combination according to the invention from FIG. 1 consists of a baby carriage 1 and a trailer 2. A children's bicycle 3 is anchored to the vehicle combination by means of two retaining devices 4, 5.

The first retaining device 4 is located on the trailer 2 and is formed by an approximately horizontal platform 6 and a slot 7 which extends within the platform 6 and is intended for positioning of the children's bicycle 3 by way of its rear wheel.

The second retaining device 5 is rigidly attached to the handlebar 8 of the baby carriage 1 and has multiple prongs 9 which are directed upward and the upper ends of which are spaced apart from one another, with the result that the handlebar 11 of the children's bicycle can be inserted from above between multiple prongs 9.

The platform 6 of the trailer 2 is preferably anchored to the baby carriage 1 in such a way that it can be pivoted with respect thereto about a horizontal axis, but not about a vertical axis. In keeping with this, the platform 6 is stabilized against the underlying surface by one or more casters 10. The relative pivotability about a horizontal axis means that the vehicle combination also copes well when the ground is uneven. Since there is no relative pivotability about vertical axes, the trailer 2 always remains in the same position in relation to the baby carriage when corners are taken, which means that simple retaining devices for the children's bicycle are sufficient, and nevertheless with good steerability of the vehicle combination.

The vehicle combination according to the invention from FIG. 2 consists of a baby carriage 1 and a trailer 12. In turn, a relatively small children's bicycle 13 is anchored to the vehicle combination by means of two retaining devices 14, 15.

The first retaining device 14 is located on the trailer 12 and is formed by a support part 16, which has two upwardly raised regions spaced apart from one another, each of which has an upwardly open notch 17 on its upper side, wherein the two notches 17 are arranged in line with one another and spaced apart from one another in such a way that there is space between them for the rear wheel of the children's bicycle 13 and a respective axle end of the rear wheel axle rests on a base of the notches 17.

The second retaining device 15 is in turn located on the handlebar 8 of the baby carriage. It is formed very simply by an intrinsically closed band loop which runs both around a rod of the handlebar 8 and around the center part of the longitudinal part of the handlebar 18 of the children's bicycle 13.

The trailer 12 in turn has an approximately horizontal platform 19 and a caster 20 in the form of a stabilization against the underlying surface, the platform 19 being attached to the baby carriage 1 and being able to pivot with respect thereto only about a horizontal axis. In addition, in the example shown in FIG. 2, the trailer 12 also has a seat surface 21, which has a raised arrangement with respect to the platform 19 by means of a support and on which an infant can sit if required.

According to an advantageous further development, the retaining device 14 can be detachably secured to the platform 19 in a plurality of different relative positions with respect thereto. For example, it can be pushed onto the platform 19 either to the left or right of said platform by means of push-fit connections between bolts and receiving bores. Said retaining device may be securable to the platform 19 either further to the front or further to the rear; this adjustable securability may again be implemented by push-fit connections, or else by a type of rail guide via which the retaining device 14 is connected to the platform 19.

These options allow the children's bicycle 13 to be positioned in an optimizable manner on the basis of personal habits of the users and/or of individual designs or overall sizes of the children's bicycle 3.

The retaining device 14 preferably has a safeguard mechanism, which protects the wheel, resting in the retaining device 14, of the children's bicycle 13 on the retaining device 14 from jumping out in an unwanted manner. For example, this safeguard mechanism may be a belt, by way of which the wheel is additionally secured to the retaining device 14, or it may be formed by a pivotable bracket, which is pivoted via an axle end of the rear wheel axle of the children's bicycle 13 to close the safeguard mechanism.

The retaining device 5, 15 on the handlebar 8 of the baby carriage 1 can preferably also be secured by choice in different positions. For this purpose, for example, a retaining device 5, 15 may have clamping parts, which can optionally be moved toward or away from one another by means of screws, and as they are moved may either clamp or not clamp to a selectable region of the handlebar 8.

As illustrated in the two drawings, the rear wheel of the children's bicycle 3, 13 is preferably secured to the lower retaining device 4, 14, which is on the trailer, and the region around the front wheel is raised further. In principle, however, it is also possible to secure the front wheel to the retaining device 4, 14 on the trailer and to raise the region around the rear wheel and secure it to the handlebar 8.

Provided that the retaining device 4, 14 on the trailer 2, 12 has a very tight and stable design, it is also possible to move a children's bicycle 3, 13 along with the vehicle combination by only securing one wheel of the children's bicycle 3, 13 to the retaining device 4, 14 on the trailer 2, 12, and the second wheel of the children's bicycle 3, 13 rests and rolls on the underlying surface (street or sidewalk). For reasons of space and lack of stability, this means of transport is recommended only for very short distances and distances without significant curves or unevennesses.

According to an advantageous further development of the invention, a cover (not illustrated) movably anchored in the vicinity of the retaining device 5, 15 on the baby carriage 1 can if appropriate be pivoted over regions of the children's bicycle 3, 13 carried along on the vehicle combination, with the result that it covers at least partial regions of the children's bicycle 3, 13. Primarily, this makes it possible to prevent clothing from being soiled when it brushes against the children's bicycle 3, 13. This cover does not need to be designed as a rigid body; it may also be formed entirely or partially from a flexible, flat material such as a plastic film. The retaining device on the baby carriage does not necessarily have to be arranged on the handlebar 8. In principle, it is also possible to connect it to other frame parts.

1. A vehicle combination which comprises a baby carriage and a trailer connected thereto, wherein the trailer comprises a platform and at least one caster that stabilizes the platform against the underlying surface,
wherein
the vehicle combination has two retaining devices for connection to a children's bicycle, wherein the first retaining device is located on the trailer and is designed to secure a wheel of the children's bicycle, and wherein the second retaining device is located on the baby carriage and is designed to secure that region of the children's bicycle which is located close to the handle region of the baby carriage when the children's bicycle is pivoted upward about the axis of the wheel secured to the retaining device on the trailer.

2. The vehicle combination as claimed in claim 1, wherein the retaining device on the baby carriage is located on the handlebar of the baby carriage.

3. The vehicle combination as claimed in claim 1, wherein the plat-form can be pivoted about a horizontal axis with respect to the baby carriage, but not about a vertical axis, and in that it is stabilized against the underlying surface by one or more casters.

4. The vehicle combination as claimed in claim 1, wherein the retaining device on the trailer can be secured by choice in different positions with respect to the platform of the trailer, and/or in that the retaining device on the baby carriage can be secured by choice at different positions with respect to the baby carriage.

5. The vehicle combination as claimed in claim 1, wherein the retaining device on the baby carriage has multiple prongs which are directed upward and the upper ends of which are spaced apart from one another.

6. The vehicle combination as claimed in claim 1, wherein the retaining device on the baby carriage comprises an intrinsically closed band loop.

7. The vehicle combination as claimed in claim 1, wherein a cover which is movably anchored in the vicinity of the retaining device on the baby carriage can cover a region of the children's bicycle which may be anchored to this retaining device.

8. The vehicle combination as claimed in claim 1, wherein the retaining device on the trailer has a closable safeguard mechanism which, when it is in the closed state, and the wheel of a children's bicycle is located in the retaining device, blocks the removal of the wheel from the retaining device.
